(19) United States
(12) Patent Application Publication
(10) Pub. No.: US 2011/0270826 A1
(43) Pub. Date: Nov. 3, 2011

(54) DOCUMENT ANALYSIS SYSTEM

(76) Inventors: Wan-Kyu Cha, Seoul (KR); Mi- Kyung Jung, Seoul (KR); Han-Joon Ahn, Seoul (KR); Jeong-Joong Kim, Seoul (KR); Sung-Ho Choi, Seoul (KR)

(21) Appl. No.: 13/142,553

(22) PCT Filed: Oct. 27, 2009
(86) PCT No.: PCT/KR2009/006235

§ 371 Date: Jun. 28, 2011

(30) Foreign Application Priority Data
Feb. 2, 2009 (KR) 10-2009-0008027
Feb. 2, 2009 (KR) 10-2009-0008029
Feb. 2, 2009 (KR) 10-2009-0008031
Feb. 2, 2009 (KR) 10-2009-0008032

(51) Int. Cl. G06F 17/30

(52) U.S. Cl. 707/723; 707/769; 707/737; 707/E17.014; 707/E17.046

(57) ABSTRACT

A document analysis system includes a database that stores documents, a document evaluation module that evaluates the documents by using features of the documents, and a user interface (UI) output unit that provides an evaluation result of the documents, which is produced by the document evaluation module, upon call of the documents.

### TECHNICAL FIELD

The present disclosure relates to a system which is capable of evaluating documents by using their features, confirming the technological development trend of the patent by using the evaluation result, and providing users with the mutual relationship of patent documents or the indirect citation relationship of patent documents.

Also, embodiments provide a system which clusters and automatically classifies a plurality of patent documents by using the indirect citation relationship of documents, and analyzes and evaluates the classified documents.

### BACKGROUND ART

A patent applicant who wants to obtain a patent should prepare documents meeting prescribed requirements and submit them. The patent application documents submitted to the patent office are laid open when a predetermined time elapses, or when they met prescribed requirements. Those documents can be referred to as patent documents.

Generally, a person who intends to file a patent searches these patent documents in order to confirm whether the prior art exists or not. In most cases, the patent document search is conducted by the input of keywords.

Recently, the importance of evaluation on these patent documents which may be used as a standard for measuring the technological levels of enterprises, countries or research institutions such as universities is gradually increasing. For example, the accurate evaluation of the patent levels or directions of enterprises and so on is indispensable to the technological strategies of the enterprises, the investor's investment decision, and the judgment on the researcher's ability, and it is applied similarly to countries or research institutions such as universities.

With the recent technological developments, the number of patent applications is increasing, and thus, the quantity of patent documents is also increasing. Accordingly, the searching of patent documents is difficult, which is conducted for preventing the duplicate researches, or confirming the right infringement, or searching the prior art before filing the patent application, or examining the technological development of other companies, or promoting the research and development.

In a related art search system for searching or examining these patent documents, a large quantity of unnecessary information may be included if inadequate keywords are selected. In such a case, it takes much time to make the examination itself.

### DISCLOSURE OF INVENTION

### Technical Problem

If the evaluation values of patent documents searched among a vast quantity of patent documents by a search query inputted by the user can be derived according to the internal standard and the derived evaluation values can be displayed to the user as the search result, the user's search efficiency of the patent documents will be increased.

In this regard, embodiments provide a system that sets evaluation factors according to features of patent documents, evaluates the patent documents by using the set evaluation factors, and displays the evaluation result values through a user interface, thereby increasing the search efficiency of the patent documents.

Furthermore, embodiments provide a system that can derive features from patent documents, evaluate the patent documents by using the derived features, and temporally analyze the patent documents by using the evaluation values.

Moreover, embodiments provide a system that can perform more efficient classification and clustering on patent documents by reading the reference or citation relationship between a plurality of patent documents, or reading the indirect citation relationship, even if it is not the direct citation relationship, and can more efficiently provide the document classification and clustering results to the user.

### Solution to Problem

In one embodiment, a document analysis system includes: a database that stores documents; a document evaluation module that evaluates the documents by using features of the documents; and a user interface (UI) output unit that provides an evaluation result of the documents, which is produced by the document evaluation module, upon call of the documents.

In another embodiment, a document analysis system includes: a database that stores documents; a document evaluation module that evaluates the documents by using features of the documents; a prediction module that temporally analyzes the documents subject to analysis by using evaluation values that are an evaluation result of the documents by the document evaluation module; and a UI output unit that provides a user with a temporal analysis result produced by the prediction module.

In further another embodiment, a document analysis system includes: a database that stores patent documents; a UI output unit that provides an evaluation result of the documents, which is produced by the document evaluation module, upon call of the documents; and a document classification module that reads an indirect citation relationship between the patent documents, and clusters patent documents of a first group by using the read indirect citation relationship.

### Advantageous Effects of Invention

According to the proposed system, the user can confirm the evaluation values of the system with respect to searched documents, as well as the list of the searched documents, thereby increasing the document search efficiency.

Also, the system evaluates the patent documents by using the preset factors, and temporally analyzes the evaluated patent documents to provide trend information to the user.

In addition, even though there is no user's request, the system previously evaluates the corresponding patent documents and manages the evaluation values when new patent documents are stored in the database, so that the user can conduct the trend analysis more easily.

Furthermore, the system can perform more efficient classification on patent documents by reading the reference or citation relationship between a plurality of patent documents, or reading the indirect citation relationship, even if it is not the direct citation relationship.

Furthermore, as the efficient document classification is performed, the patent development through the patent documents can be achieved efficiently.

Moreover, since the efficient document classification and clustering results are provided to the user through various UIs, the user can easily perform the analysis of the patent documents.

### BRIEF DESCRIPTION OF DRAWINGS

FIG. 1 is an exemplary view illustrating the structure of a document analysis system according to an embodiment.

FIG. 2 illustrates the structure of evaluation factors of patent documents.

FIGS. 3 and 15 are exemplary views illustrating document search and evaluation results according to an embodiment.

FIG. 4 illustrates an example of a patent document analysis UI provided to a user.

FIG. 5 is a flowchart illustrating a case where the user confirms the evaluation factors and edits the items of the evaluation factors or the assigned evaluation values.

FIG. 6 illustrates an example of trend information that is generated using patent documents subject to analysis by the document analysis system according to the embodiment.

FIG. 7 illustrates an example of a UI for setting inflection period.

FIGS. 8 and 9 illustrate examples of the patent document analysis UI within the inflection period according to an embodiment.

FIG. 10 illustrates an example of a document clustering unit of the document classification module according to an embodiment.

FIG. 11 illustrates a structure that derives the indirect citation relationship through the document classification module according to an embodiment.

FIG. 12 illustrates a structure that clusters similar documents into the classified groups through the document classification module according to an embodiment.

FIG. 13 illustrates an example of attribute information of category documents or attribute information of documents of a second group according to an embodiment.

FIG. 14 illustrates an example of feature vectors obtained from category documents or documents of the second group according to an embodiment.

FIGS. 16 and 17 illustrate examples of a UI that is provided to the user as the document classification or clustering result according to an embodiment.

FIGS. 18 to 22 illustrate various kinds of UIs that are provided to the user as the document classification and clustering results according to an embodiment.

### BEST MODE FOR CARRYING OUT THE INVENTION

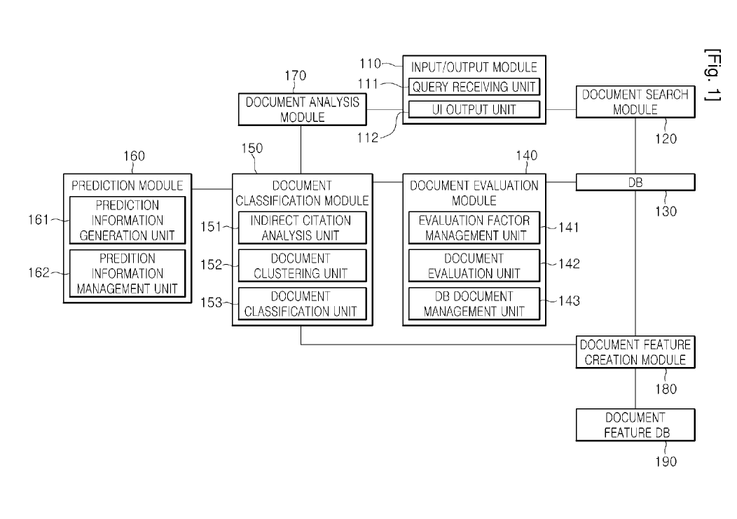

FIG. 1 is an exemplary view illustrating the structure of a document analysis system according to an embodiment.

Referring to FIG. 1, the system according to the embodiment is implemented in a server or a computer and may include an input/output module 110, a document search module 120, a database 130, a document evaluation module 140, a document classification module 150, a prediction module 160, and a document analysis module 170.

A query receiving unit 111 of the input/output module 110 is configured to receive a query inputted by a user through a keyboard or a mouse in order to perform document search or analysis. The query inputted by the user may be a keyword which is described in patent documents stored in the database 130 (or accessible through a network). The keyword includes not only characters but also numbers such as application number or publication number, which configure the patent document.

A user interface (UI) output unit 112 of the input/output module 110 provides the user with information operated or extracted by the document search module 120, the document evaluation module 140, the document classification module 150, the prediction module 160 or the document analysis module 170. Although it is described below that the UI output unit 112 is a device providing various UIs, it is apparent that the UI output unit 112 may be provided within other component of the document analysis system according to embodiments.

The document search module 120 searches patent documents to be called among patent documents stored in the database 130, based upon the query inputted by the user. The search operation of the document search module 120 will be described below.

The patent document search can be performed with respect to patent documents stored in the database 130 by using the keyword inputted by the user and a keyword similar to the inputted keyword.

The document search module 120 searches patent documents to be called among patent documents stored in the database 130, based upon the query inputted by the user. In the patent document search by the document search module 120, a document feature creation module 180 and a document feature DB 190 may be used.

The document feature creation module 180 may extract texts from the documents stored in the database 130 and provide the document feature DB 190 with index information on frequency by keyword. When receiving a predetermined query through the query receiving unit 111, the document search module 120 can search documents containing the query by using index files of the document stored in the document feature DB 190.

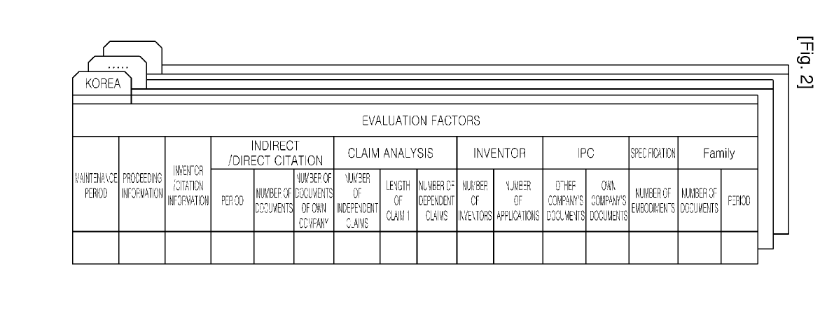

The documents searched by the document search module 120 may be provided through the UI output unit 112 to the user by the UI, as illustrated in FIG. 3.

When a predetermined query is received through the query receiving unit 111, or new documents are stored in the database 130 by a web robot, the document feature creation module 180 can create index files of the corresponding documents and determine feature vectors for documents by using the index files, which will be described below with reference to FIG. 13.

FIG. 13 illustrates attribute information of documents. Attribute information of the documents illustrated in FIG. 13can be created in an index file format by the document feature creation module 180, and the created index files are stored in the document feature DB 190.

The document feature creation module 180 can determine the feature vectors of the documents by using the index files stored in the document feature DB 190, and the feature vectors also can be stored in the document feature DB 190.

Information on occurrence frequency by keyword (A,B,C,D,M,I,K,O,P,Q,Z) in documents is illustrated in FIG. 13. For example, in the first document, the keyword A (herein, A represents not an alphabet but a word such as a noun, a proper noun and a compound noun), the keyword B, the keyword C, and the keyword D are contained thirty-five times, nineteen times, fifteen times, and thirteen times, respectively.

As illustrated in FIG. 13, an occurrence frequency table by a keyword contained in documents may be created so that keywords are sequentially arranged in a descending order from the highest frequency to the lowest frequency.

For example, in order to represent that the keyword A, the keyword B, the keyword C, and the keyword D are 4.5%, 2.4%, 1.9%, and 1.7% in the document 1, respectively, the index file of the document 1 may be created so that it contains the meaning of (A, B, C, D) (4.5%, 2.4%, 1.9%, 1.7%).

In this way, the index files of the documents can be created in various manners, and the feature vectors of the documents can be extracted using the created index files.

Specifically, the document feature creation module 180 creates the table based upon the occurrence frequency by keywords in the documents, and also creates the feature vectors of the documents by using the created table.

The feature vector determined by the document feature creation module 180 includes evaluation values of the keywords with respect to the document. For example, if a total number of the keywords included in the document is n, the feature vector of the document can be expressed as n-dimensional space vector like Equation (1) below.

Feature vector=(evaluation value w1 of keyword A,evaluation value w2 of keyword B, . . . ,evaluation value wn of word n) (1)

The evaluation value may be calculated using a tf·idf method disclosed in a document (Salton, G: Automatic Text Processing: The transformation, Analysis, and Retrieval of Information by Computer, Addison-Wesley). According to the tf·idf method, a value other than zero is yielded as the evaluation value for components corresponding to the keywords included in the first document among n-dimensional feature vectors of the first document, and zero is yielded as the evaluation value for components corresponding to the keywords (words having the frequency of zero) which are not included in the first document.

In this respect, the evaluation value of the keyword as one component of the feature vector may be the frequency rate of the keyword included in the document. For example, the keyword A, the keyword B, and the keyword C from the first document can be clustered as a similar word by the document search module 120, and the clustered similar word may be separately stored in a similar word DB.

That is, predetermined keywords A and B are clustered by the document search module 120, and the clustered keywords A and B are stored in the similar word DB.

If one of the keywords A and B is included in the extracted keywords, the document search module 120 searches similar documents including the other keyword.

The search is not limited to the extracted keywords, but the search of the similar documents may be conducted, based upon the attributes of the patent documents.

If the keyword A is included in the queries received through the query receiving unit 111, the search of the documents including the keywords A, B and C may be conducted during the similar document search.

In addition, the patent document data are stored in the database 130 according to this embodiment, and the patent document data group is a database configured to store document data of specifications related to electronic patent applications or patents. The patent document data are data that contain text data describing the contents of the specifications by character codes. Other plain text data, for example, document data containing a description by general-purpose tag language such as Standard Generalized Markup Language (SGML), HyperText Markup Language (HTML), or eXtensible Markup Language (XML) are also possible. If the text data can be extracted, other formats such as Portable Document Format (PDF) or document format of general-purpose word processor, or Rich TextFormat (RTF) format are also possible.

The patent document database 130 may be provided outside the document analysis system. In this case, the document analysis system accesses the database through the network and acquires the document data of the patent documents.

The document evaluation module 140 according to this embodiment evaluates the patent documents, which are stored in the database 130 or accessible through the network, by using the attribute information of the patent documents, and also provides the evaluation result to the UI output unit 112 to display it to the user. The UI output unit 112 can provide the user with information about the evaluation values of the searched patent documents together with the search result list of the patent documents, and can provide information about the evaluation values of the patent documents on a pop-up window or an OSD, separately from the search result list.

The document evaluation module 140 creates an evaluation item table by using set evaluation items with respect to the patent documents which are stored in the database 130 or accessible through the network, and such an evaluation work may be performed whenever new patent documents are stored in the database 130.

The evaluation work of the patent documents by the document evaluation module 140 may be performed when the user requests the document search and documents are searched. It is noted that the following description will be made without limitation of time at which such an evaluation work is performed.

The document evaluation module 140 may include an evaluation factor management unit 141 that manages the features of the patent documents as evaluation factors, a document evaluation unit 142 that evaluates the patent documents stored in the database 130 by using the evaluation factors, and a DB document management unit 143 that makes the evaluation values, which are the document evaluation result by the document evaluation unit 142, correspond to the patent documents.

The evaluation factor management unit 141 manages the items for internal features and external features of the patent documents stored in the database 130, and those features can be edited by the user.

That is, the structure of the evaluation factors for the internal features and the external features of the patent documents by the evaluation factor management unit 141 is illustrated in FIG. 2. FIG. 2 illustrates the structure of the evaluation factors of the patent documents.

As illustrated in FIG. 2, the attribute tables of the patents described by the evaluation factor management unit 141 may be arranged by countries, and the tables include the internal features derived from the contents described in the patent documents, and the external features derived considering the features of documents cited by the patent documents.

The internal features derived from the contents described in the patent documents refer to keywords or information about the corresponding patent documents which can be extracted through a text mining work with respect to the contents described in the patent documents.

For example, a maintenance period calculated from a registration date recorded in the patent document to a current date can be derived from the contents described in the patent document. Thus, the maintenance period may be the internal feature of the patent document.

Also, proceeding information calculated from a filing date described in the patent document to a current date, the number of independent claims in the patent document, a length of claim that can be determined according to the number of keywords derived from a text mining with respect to a specific independent claim, the number of dependent claims which can be identified from specific phrases such as “ [symbol] [symbol] ” or “according to claim 1” may also be the internal features of the patent document.

Furthermore, the number of inventors described in the patent document may also be the internal feature of the patent document.

However, the number of patents filed by “A” recorded as an inventor in the first patent document is the external feature of the patent document because other patent documents where “A” is recorded as the inventor must be searched.

When there are other patent documents cited in the corresponding patent document, the number of the cited patent documents and the cited/citing period are the external features of the patent document.

In order to calculate the evaluation values for grading the patent document, the evaluation factors for the patent document must be defined, and the evaluation values for the corresponding patent can be calculated by calculating the weighting values for the defined evaluation factors.

Therefore, using the exemplary table of FIG. 2, the evaluation factor management unit 141 creates the evaluation factor items for the patent documents stored in the database 130. Although the internal features and the external features are randomly arranged in FIG. 2, the evaluation values for the internal features, which can be obtained from the information extracted within the patent documents, and the evaluation values, which are calculated from the relation between the corresponding patent document and other patent documents (other patent documents within the search result and other patent document having the same technical field stored in the database are possible) may be discriminated as separate items.

The values of the features read out from the patent documents are recorded in the table as illustrated in FIG. 2, and then, the evaluation values of the patent documents are calculated by the document evaluation unit 142.

For example, the weighting values are previously assigned to the evaluation factors. In this case, since the weighting values are calculated on the internal features and the external features extracted from the patent documents, the sum of the scores of the evaluation factors may be the evaluation value of the corresponding patent document.

The evaluation values of the patent documents calculated in such a manner may be separately managed by the DB document management unit 143, and the calculated evaluation values of the patent documents contained in the search result are also displayed to the user together with the patent document search result.

Accordingly, the UI output unit 112 of the input/output module 110 provides the user with the items of the evaluation factors or the table, which are managed by the evaluation factor management unit 141, and the contents of the evaluation factors added, edited and deleted by the user are stored and managed by the evaluation factor management unit 141.

A list of the document search result provided to the user's computer or server is illustrated in FIG. 3. For example, when the document search module 120 searches and reads seven patent documents from the database 130 with respect to the query inputted by the user, the evaluation values of the patent documents are displayed together with bibliographic information of the searched patent document (for example, patent number, status, filing date, issue date, title of the invention, IPC).

In addition, the document evaluation unit 142 provides the evaluation values of the patent documents to the UI output unit 112 so that the user can rapidly discriminate patents having the highest worth from other patents among the searched patent documents. The average evaluation value of the searched patent documents, as well as the evaluation values of the patent documents, is calculated. The calculated average evaluation value can also be provided to the UI output unit 112.

If displaying the average evaluation value of the searched patent documents together, the user can easily determine superiority and inferiority of the searched patent documents. According to this embodiment, the user can improve the search efficiency by first confirming the patent documents having high evaluation values.

In this respect, the document evaluation unit 142 can calculate the average evaluation value in the technical field to which the searched patent documents pertain, and the UI output unit 112 can also provide the average evaluation value in the technical field to which the corresponding patent documents pertain, together with the respective evaluation values of the searched patent documents.

In this case, whether the technical fields to which the searched patent documents pertain are common can be determined by IPC which is an international classification system, or F-term which is a classification system developed by Japanese Patent Office. Also, when the patent documents classified as different technical fields must be displayed as the search result, the average value of the evaluation values for the technical fields to which the patent documents occupying a majority ratio in the search result perform can be provided.

In this case, the user can easily grasp the importance of the searched patent documents by comparing the evaluation values assigned to the searched patent documents with the average evaluation value of the patent documents belonging to the corresponding technical field.

Meanwhile, the function of enabling the user to selectively download the search result list can be provided. Upon download of the search result list, the information about the evaluation values calculated by the document evaluation module 140 can also be provided to the user's computer or server.

Furthermore, in the UI of the search result illustrated in FIG. 3, if the user clicks a specific weighting value in order to confirm details of the evaluation values assigned to the patent documents, a separate UI may be provided which enables the user to confirm in detail the evaluation factors constituting the evaluation values and the scores assigned to the corresponding patent document with respect to the evaluation factors.

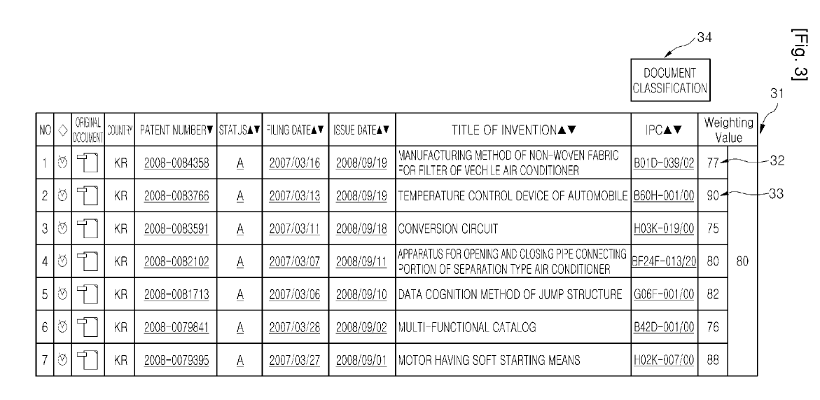

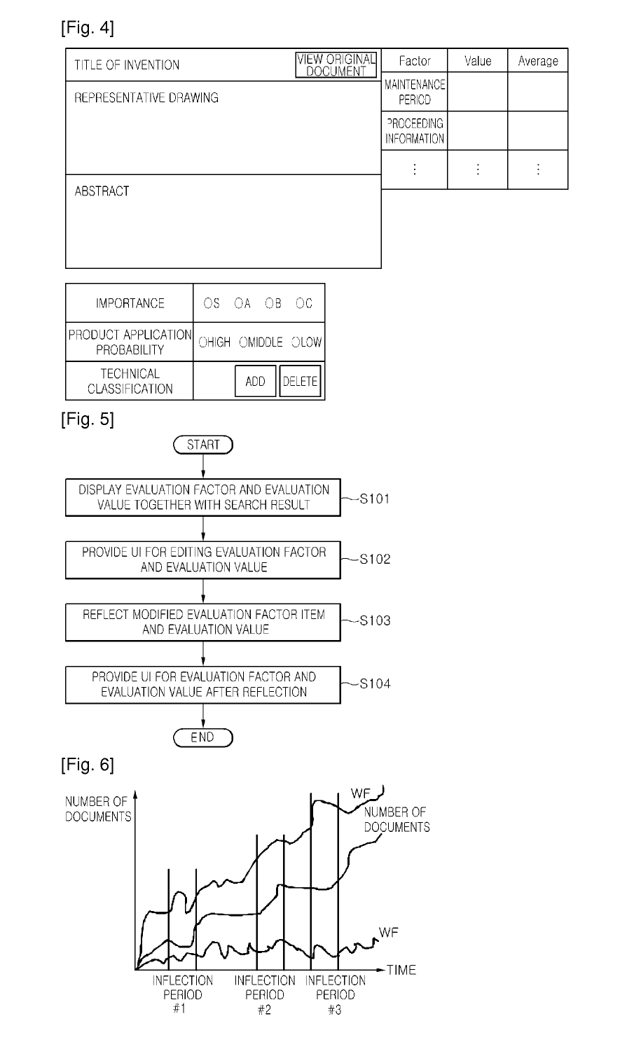

Moreover, in the UI including the search result list as illustrated in FIG. 3, when the user selects a specific patent document, a separate window (UI) may be generated which shows the abstract of the corresponding patent document. That is, as illustrated in FIG. 4, a patent document analysis UI may be provided to the user, and information about the evaluation value of the corresponding patent document is provided in the patent document analysis UI.

For example, the items of the evaluation factors applied to the corresponding patent document, and information about the scores of the items can be provided together with the title of invention, representative drawing, and abstract of the selected patent document. As mentioned above, the average evaluation factor values of the searched patent documents or the patent documents belonging to the same technical field as the corresponding patent can also be provided.

The user can modify and edit the displayed evaluation factor items by manipulating his/her own server or computer, and can separately edit the assigned scores. To this end, the evaluation factor management unit 141 and the DB document management unit 143 of the document evaluation module 140 change information about the corresponding patent document according to the items and scores of the evaluation factors modified by the user.

FIG. 5 is a flowchart illustrating the case where the user confirms the evaluation factors and edits the items of the evaluation factors or the evaluation values assigned thereto.

As a response to the user's search request, the document evaluation on the patent documents to be outputted is conducted by the document evaluation module 140, and the evaluation values calculated by the document evaluation module 140 are provided to the user together with the individual evaluation items (S101).

When the user selects the evaluation items and the evaluation values provided together with the search result list, or selects the searched patent documents, the evaluation items and the evaluation values can be edited (S102). The edit operation of additionally selecting the evaluation items or deleting the selected items, and the operation of directly modifying the evaluation values assigned by the document evaluation module 140 can be performed.

In this case, the contents edited by the user can be set so that they are reflected only on the searched patent documents or other patent documents belonging to the same technical field as the corresponding patent. The document evaluation module 140 recreates the evaluation values of the evaluation items, based upon the modified contents (S103).

Then, the evaluation values re-created by the document evaluation module 140 may be provided to the user through a separate UI by the UI output unit 112 (S104).

The modification of the evaluation factors for evaluating the patent documents may be construed as including the addition, deletion and edition of the items of the evaluation factors, and whether to apply the evaluation factors or scores modified by the user to all the patent documents stored in the database 130, or whether to apply them only to the searched patent documents like in FIG. 3 may be appropriately changed according to the applied embodiments of the system.

Next, the structure and method of acquiring the trend information of the patent documents by using the prediction module 160 will be described below.

Referring again to FIG. 1, the documents are evaluated by the document evaluation module 140, and the prediction module 160 performs a temporal analysis on the patent documents by using the result given when the weighting values are assigned by the document evaluation module 140.

As mentioned above, if the evaluation values are assigned to the patent documents by the document evaluation module 140, the prediction module 160 performs a temporal analysis on the patent documents to which the evaluation values are assigned.

The prediction module 160 classifies the patent documents, which are subject to analysis, in time order such as years or months, and generates trend information by using the evaluation values of the patent documents assigned by the document evaluation module 140.

Specifically, the prediction module 160 includes a prediction information generation unit 161 that classifies the patent documents, which are subject to analysis, in time order, based upon the filing dates or publication dates (or registration dates) described in the patent documents. The prediction information generation unit 161 generates the number of the patent documents, which are classified by preset classification periods, and the evaluation values of the classified patent documents as the trend information.

Furthermore, the prediction module 160 includes a prediction information management unit 162 that sets the classification periods which may be used as the classification standard of the patent documents when the prediction information generation unit 161 generates the trend information. The prediction information management unit 162 automatically sets the inflection periods from the trend information, or enables the user to set the inflection periods.

The prediction information management unit 162 automatically sets the inflection periods from the change information of the evaluation values of the patent documents according to the time order provided by the prediction information generation unit 161, or enables the user to directly set the inflection periods. In case where the user sets the inflection periods, the UI output unit 112 of the input/output module 110 connected to the prediction module 160 provides the user's computer with a UI for setting up the inflection periods.

The patent documents on which the trend analysis is performed by the prediction module 160 may be patent documents selected by the user, or patent documents corresponding to the search result of the document search module 120. Therefore, the patent documents on which the trend analysis is performed by the prediction module 160 may be patent documents related to IPC or F-term, or patent documents which are similar in technical field, or problems to be solved by the invention, or effects.

Hereinafter, the analysis operation of the patent documents by the prediction module 160 will be described with reference to FIG. 6.

FIG. 6 illustrates an example of trend information that is generated using the patent documents subject to analysis by the document analysis system according to this embodiment.

Like the case of FIG. 6, the trend information generated by the prediction module 160 can be provided to the user in a form of a graph which has a time axis and another axis representing the number of patent documents and the evaluation values. For reference, the term “trend information” is used in the sense that information about the number of patent documents, the sum of the evaluation values assigned to the patent documents, and the average evaluation value per a patent document is provided to the user. In view of the trend information, periods where the number of the patent documents is rapidly changed, or the evaluation values of the patent documents are rapidly changed, or the average evaluation value per a patent document is rapidly changed may be called inflection periods.

Since the definition of the inflection period can be changed or applied in various manners according to embodiment, the period where the range of change in the sum of the average values for patent documents within the period or the average evaluation value per a patent document within the corresponding period is relatively great can be called the inflection period in the disclosure of this invention.

However, since the user can directly set the inflection period while viewing the trend information illustrated in FIG. 6, the specific definition about the meaning of the inflection period is not necessarily needed. The period for the user to perform the detailed analysis on the patent documents within a specific period while viewing the trend information of FIG. 6 provided by the document analysis system may be called the inflection period.

The user can set the inflection period with respect to a time axis from the trend information provided by the prediction module 160, and the setting of the inflection period is done for analyzing the patent documents within the corresponding period in further detail.

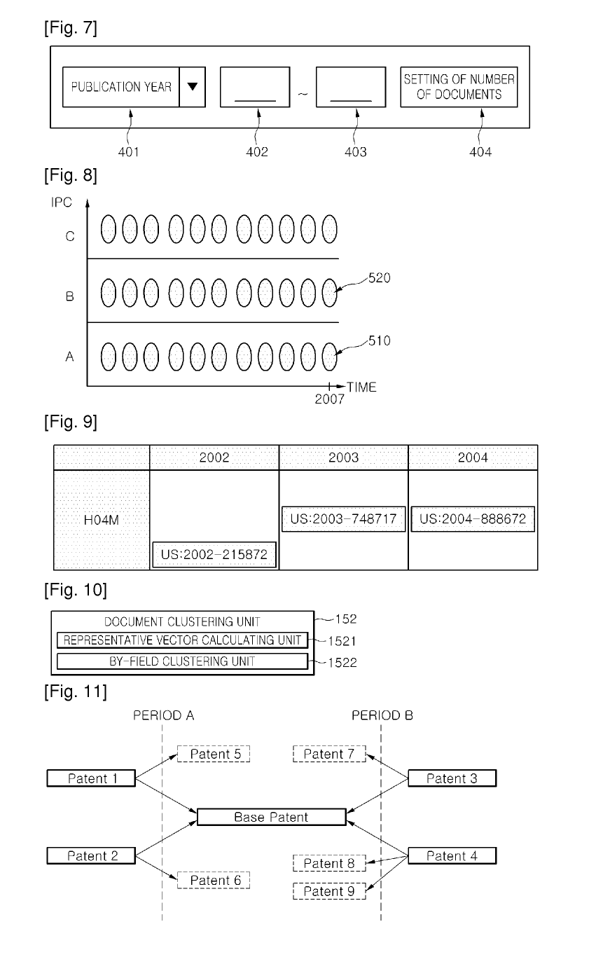

A setting UI provided for enabling the user to set the inflection period from the trend information is illustrated in FIG. 7. Referring to FIG. 7, the UI for setting the inflection period may include a year setting tag 401 that sets an application year or publication year described in the patent document in order to determine kind of time, tags 402 and 403 tat set a start year and an end year in order for setting an analysis period according to the selected standard, and a tag 404 that sets the number of patent documents to be analyzed within the set inflection period.

In the UI for setting the inflection period, the number of the patent documents set by the tag 404 that sets the number of the patent documents is smaller than a total number of patent documents included within the corresponding inflection period, the patent documents having the high evaluation values assigned may be preferentially subject to analysis within the inflection period. For example, if the inflection period set by the user is an inflection period #1 in FIG. 6; the number of the patent documents included within the corresponding inflection period is 200; and the number of the patent documents set by the user through the setting tag 404 of the setting UI is 100, 100 patent documents among the 200 patent documents may be subject to analysis within the inflection period in descending order of the evaluation value assigned by the document evaluation module 140.

Meanwhile, it is possible to further form a tag within the setting UI that can determine whether to perform the analysis, focusing on the patent documents having the high evaluation values or the patent documents having the low evaluation values.

Inflection periods set by the user or automatically set are illustrated in FIG. 6. The inflection period #1 is a period in which the number of the patent documents mostly decreases, the sum WF of the evaluation values of the patent documents rapidly increases and decreases, and the average evaluation value of the patent documents repetitively decreases and increases.

In the inflection period #1, since there is a period in which the sum of the evaluation values increases despite the number of the patent documents decreases, it may be expected that the inflection period #1 is a period in which the technical development direction (trend) is changing. Such a period may be called a period having a gradual inflection.

Meanwhile, in the inflection period #2, the sum of the evaluation values also steadily increases with the steady increase of the patent documents, but a period in which the average evaluation value per a patent document decreases is included. Since the average evaluation value decreases, such a period may be considered as a period in which many small inventions have been researched in view of the inventive step of the technology. Such a period may be considered as an inflection period having the decreasing trend.

The user can set an appropriate period as the inflection period through the setting UI, under determination from the trend information of FIG. 6, and the UI illustrated in FIG. 8 or 9 may be provided to the user in order for detailed analysis of the set inflection period. Such a UI is also provided to the user's server or computer through the prediction module 160 and the input/output module 110.

FIGS. 8 and 9 illustrate an example of the patent document analysis UI within the inflection period according to an embodiment.

First, FIG. 8 illustrates a UI that analyzes the patent document within the inflection period within the inflection period set by the user or set according to the predetermined standard of the document analysis system. As an example, the UI has an x-axis representing time and a y-axis representing a technology classification (IPC or F-term).

The analysis of the patent documents within the selected inflection period may be performed by the prediction module 160. If the x-axis represents “by year”, the detailed analysis UI of FIG. 8 or 9 can display the trend information of FIG. 3 by month or year.

Referring to FIG. 8, information about the patent documents is displayed by the technology classification and time, and information about those patent documents may be displayed in an icon form. For example, a first icon 510 may be displayed to represent the patent documents belonging to a technology classification A of 2007, and a second icon 520 may be displayed to represent the patent documents belonging to a technology classification B of 2007.

The icons 510 and 520 may be displayed with different colors or sizes in order to relatively compare the magnitude of the sum of evaluation values of the patent documents belonging to the technology classification A or B within the corresponding year (2007). In addition, the icons may be differently displayed in order to relatively compare the magnitude of the average evaluation value per a patent document.

In this way, the user can confirm the patent technology trend by year and technology classification, as well as the information provided by the trend information of FIG. 8. Also, the technological development trend can be confirmed through the table of FIG. 9, as well as the display of the evaluation values (or the average evaluation value per a patent document) through those icons.

That is, as illustrated in FIG. 9, the detailed document analysis UI within the selected inflection period may include information about the representative patent documents by year and technology classification. For example, it is possible to display information about the patent document (US:2002-215872) to which the highest evaluation value is assigned among the patent documents belonging to the technology classification of H04M in 2002. When the user selects (clicks or drags) the information about the displayed patent documents, the system according to the embodiment may provide a separate UI that displays bibliographic information or original document of the corresponding patent document.

Although the detailed document analysis UI within the inflection period has been described with reference to FIGS. 8 and 9, the system according to the embodiment can also provide the document analysis UI within the inflection period, based upon other contents described in the patent document, instead of the technology classification, such as inventor, applicant, applicant country, or filed country.

Furthermore, although the document analysis UI within the inflection period has been illustrated in a from of graph or diagram, the system according to the embodiment can also be configured to provide the user with the document analysis UI in a form of an image or another graph using the evaluation values within the inflection period.

Next, the structure of acquiring the trend information of the patent documents by using the document classification module 150 and a method thereof will be described.

Referring again to FIG. 1, the document analysis system includes the document classification module 150 that derives the direct or indirect citation relationship of the patent documents designated by the user or stored in the database, and classifies and clusters the patent documents.

Herein, the above-mentioned description about the document search module 120, the document feature creation module 180, and the document feature DB 190 needs to be kept in mind.

That is, as mentioned above, since the search of similar documents by the document search module 120, the document feature creation module 180, and the document feature DB 190 is related to clustering of the documents, further detailed description will be made on the operation of clustering the documents after the patent documents are classified through the citation relationship analysis. Also, description will be made on the operation of evaluating the patent documents, the operation of classifying the patent documents selected by the user through the indirect citation relationship, and the operation of clustering other documents after the classification of the documents.

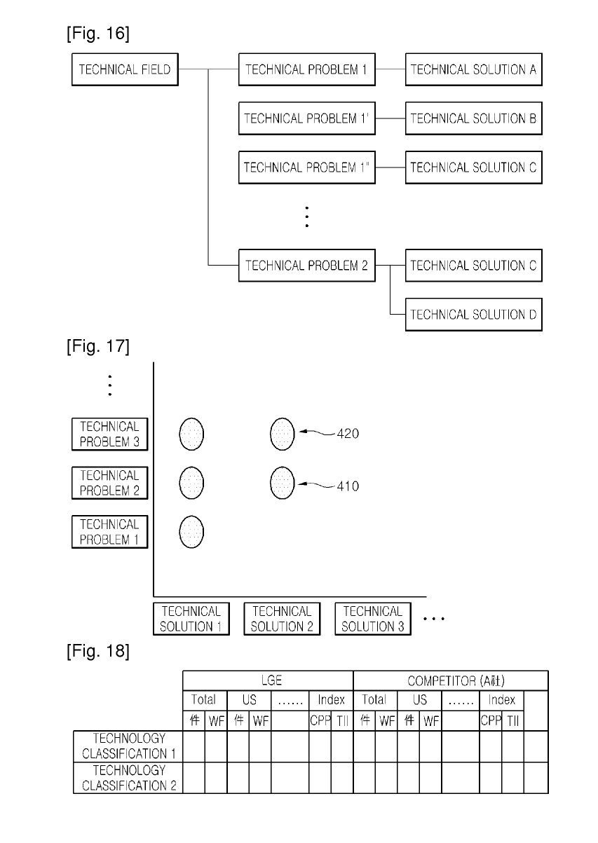

First, when the graph as the classification result by the document classification module 150 according to the embodiment displayed to the user, the patent document list as the clustering result may be provided to the user in a form of FIG. 3 or 15. However, when displaying in a form of the graph or matrix map as illustrated in FIG. 16 or 17, the patent document (representative document) to which the highest evaluation value is assigned may be displayed.

Herein, it can be seen that the document search module 120, the document evaluation module 140, and the document classification module 150 according to the embodiment operate in a combined manner rather than operate separately, in order for achieve more effective document search, classification and clustering.

Hereinafter, in case where predetermined patent documents are searched with respect to the query inputted by the user by the document search module 120 and the document feature creation module 180 and then the search result is displayed in a list form illustrated in FIG. 3, the operation of classifying the searched patent documents based upon similar technical problems (problems of the related art) or technical solutions (means for solving the problems) will be described.

That is, since the documents may be classified by using their indirect citation relationship and the patent documents having such a citation relationship tend to have common technical problems or technical solutions, it is more advantageous to classifying the patent documents given as the document search (similar search) with respect to the query inputted by the user rather classifying all the patent documents stored in the database 130.

In this respect, the operation of the document classification module 150 will be described, exemplifying the patent documents belonging to a predetermined similar range as the document search. Although the document evaluation module 140 operates even in the clustering of the documents after their classification, the information about the evaluation values assigned like in FIGS. 3 and 15 may also be provided in the document search operation prior to the classification and clustering of those documents.

Meanwhile, the UI output unit 112 may provide a tag (34, see FIG. 3) that guides the user to help performing the classification and clustering of some of the patent documents among the lists of the searched patent documents or all the searched patent documents.

If a key requesting to classify and cluster the documents is inputted, the document classification module 150 derives the indirect citation relationship of the selected patents and performs the document classification using the derived indirect citation relationship. For example, in case the first patent document is cited in the second patent document and the second patent document is cited in the third patent document, the first patent document and the third patent document have the indirect citation relationship. Thus, the document classification module 150 classifies the first and third patent documents as the same category, together with the second patent document.

Next, the citation relationship according to the embodiment, that is, the indirect citation relationship will be described. The citation relationship may form the relationship of the citing patent document and the cited patent document if there are reference document numbers of other patent documents (patent application numbers, patent publication numbers, registration numbers, and so on), which are described in order to explain the problems of the related art within the patent documents.

In addition, only the patent documents mentioned or described within the patent documents need not be limited as the cited documents, and documents referenced as the prior art/cited invention in the examination procedure or the opposition to the grant of the patent or the invalidation trial for the corresponding patent document can also be considered as having the citation relationship. Therefore, other patent documents that may be indirectly used during the examination procedure by the examiner or third parties, as well as the case where bibliographic information about other patent documents within the corresponding patent document is described, can also be considered as having the citation relationship.

In order to expand such a citation relationship, a citing and reference document storage unit may be provided in the database 130 in order to store information about whether the patent documents are cited or not. In this case, a reading unit that reads the citation relationship from documents used during the examination procedure or the procedure after the registration among documents provided by the patent office, as well as a reading unit that reads the citation relationship from the description of the patent documents, may be provided.

For example, if an examined patent publication of other patent document B is described within a patent document A, the direct citation relationship between the patent document A and the patent document B can be read out. If the examiner suggested a patent document C as the cited invention during the examination of the patent document A, the patent document C may also be considered as having the citation relationship with the patent document A.

Moreover, although there are a patent document of a first group and a patent document of a second group in the contents described in claims, the first group may be considered as a document group that is formed by performing the document classification on patent documents searched after the user's document search by using the indirect citation relationship. The second group represents other patent documents designated by the user or stored in the database 130, and it may be considered as a group of patent documents to which no document classification is performed by the document classification module 150 according to the embodiment.

Therefore, when the user makes a request to classify the searched patent documents, at least one or groups such as the first group may be generated after the document classification is performed by the document classification module 150. When the user intends to classify or cluster other patent documents (second group) after the document classification, documents belonging to the unclassified or unclustered second group may be classified or clustered as classification belonging to the first group by using features of the first group (representative document or representative vector).

For helping the understanding, it has been described above that the documents belonging to the first group are defined as being classified using the indirect citation relationship, and the documents belonging to the second group are considered as not yet being classified or clustered. However, although the documents belonging to the second group have already been classified or clustered, they have only to be again classified or clustered according to the classification standard of the first group. Thus, it is not necessarily limited to those definitions.

Furthermore, patent documents that are newly provided to the database 130 can also be automatically clustered or classified by the above-mentioned operations, depending on the user's setting. That is, document features of the documents that are newly provided to the database 130 may be created by the document feature creation module 180, the evaluation values are assigned thereto by the document evaluation module 140, and then, the documents are clustered into appropriate groups by the document classification module 150. A series of those operations may be considered as the automatic classification or automatic clustering.

In the detailed description of this invention, it should be noted that although the terms “classification” and “clustering” may be mixed in use, they are enough if being construed in association with the operation of the document classification module 150 or the document search module 120.

Meanwhile, according to this embodiment, the patent documents can also be classified using the indirect citation relationship, in addition to the reading of the citation relationship. This operation will be described below with reference to FIGS. 10 to 13.

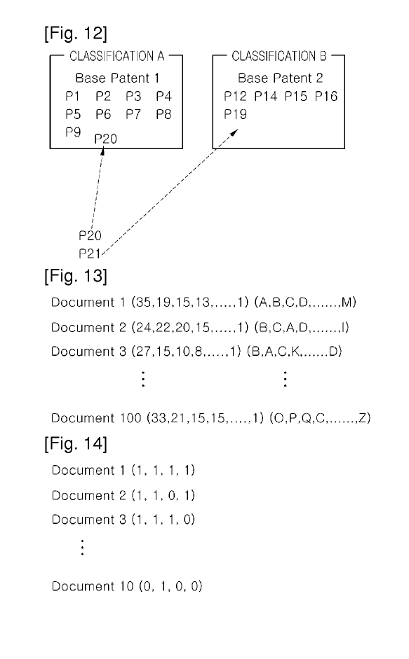

FIG. 10 illustrates an example of a document clustering unit of the document classification module according to this embodiment, FIG. 11 illustrates a structure that derives the indirect citation relationship through the document classification module according to this embodiment, and FIG. 12 illustrates a structure that clusters similar documents into the classified groups through the document classification module according to this embodiment.

First, the structure that drives the indirect citation relationship through the document classification module 150 according to this embodiment will be described below with reference to FIG. 11.

The user can acquire the information about the indirect citation relationship of the searched documents or the directly designated documents through the document classification module 150. As illustrated in FIG. 11, the user can set periods (periods A and B) with respect to the documents to be classified. In this case, the classification is performed on documents belonging to the set periods among the patent documents to be classified.

That is, even though the indirect citation relationship is not formed between the patent documents belonging to the set periods (citation relationship formed by recording the bibliographic information in the documents, or citation relationship formed by being referred by the examiner and so on), if there exists the relationship between the citing patent documents or the cited patent documents, those patent documents may be classified into the same categories in view of the indirect citation relationship.

As one example, if the periods set by the user in order for document analysis and classification are the periods A and B; patent documents (Base Patent, Patent 5, Patent 6, Patent 7, Patent 8, Patent 9) belonging to an interval between those periods are not in the indirect citation relationship; and the first patent document (Patent 1) out of the set periods is cited in the fifth patent document, the fifth patent document (Patent 5) and the base patent document (Base Patent) form the indirect citation relationship therebetween.

As another example, if the third patent document (Patent 3) directly cites the seventh patent document (Patent 7) and the base patent document (Base Patent) within the interval, the third patent document (Patent 3) and the seventh patent document (patent 7) form the indirect citation relationship therebetween, and thus, they are classified into the same category according to this embodiment.

Through such a manner, the base patent document (Base Patent) forms the indirect citation relationship with the fifth to ninth patent documents (Patents 5 to 9) in the case of FIG. 11, and thus, it can be the representative document or the base patent document.

In order to easily grasp the contents of the patent documents, the user can directly create the classification names with respect to the category units of the patent documents classified by such a manner. For example, as illustrated in FIG. 16, if the patent documents of the classified category have common technical problems of “noise reduction”, the “noise reduction (e.g., technical problem 1)” may be written as the category name.

The categories classified in such a manner may be displayed for the user in a tree form of FIG. 16, a graph form or a diagram form, and it is apparent that the categories may also be displayed in a bubble chart.

Referring to FIG. 17, if the categories classified by the user are named technical problems 1, 2 and 3 and technical solutions 1, 2 and 3, images 410 and 420 may be displayed for indicating the categories corresponding to the respective technical problems and technical problems. In this case, the images in the graph may be displayed with different colors or sizes according to sizes of the patent documents included in the respective categories, or may be displayed with different colors or sizes according to the magnitude of the sum (or average evaluation value) of the evaluation values of the patent documents included in the respective categories.

In case where data are provided to the user in the form of FIG. 16 or 17 as the document classification or clustering result, information about the above-mentioned representative patent document (base patent document) or information about the patent document to which the highest evaluation value is assigned by the document evaluation module is provided to the user if the user selects specific categories (technical solution 1, technical solution 2, technical solution 3, technical problem 1, technical problem 2, technical problem 3).

Through those procedures, the user can classify the searched documents. Furthermore, after the document classification using the indirect citation relationship, patent documents that are unclassified or classified into other indirect citation relationship, which may be considered as belonging to the second group, can be classified and clustered.

In the document clustering operation, the determination of similarity between documents by the document classification module 180 may be used, and the document classification module 150 classifies and clusters the patent documents of the second group, based upon the patent documents of the second graph that has already been classified. The document clustering unit 152 of the document classification module 150 determining the similarity between the patent document belonging to the first category of the first group (which may be the representative document of the first category) and the patent document of the second group, and determines which category of the first group the patent document belonging to the second group is classified into.

The document clustering unit 152 may include a representative vector calculating unit 1521 that calculates a representative vector necessary for clustering by using the representative document within the classified category or a plurality of documents belonging to the corresponding category.

Furthermore, the document clustering unit 152 may also include a by-field clustering unit 1522 that clusters similar documents by fields (or identification items) constituting the patent document.

The representative vector calculating unit 1521 uses index files created by the document feature creation module 180, based upon occurrence frequency by keyword from the representative document within the already formed category (base patent document or patent document selected using the evaluation value) or documents belonging to the same category. For example, the representative vector calculating unit 1521 can extract representative keywords having the high frequency among keywords of the respective documents, and can select several high-ranked keywords from the index files of the respective documents in a descending order of the occurrence frequency.

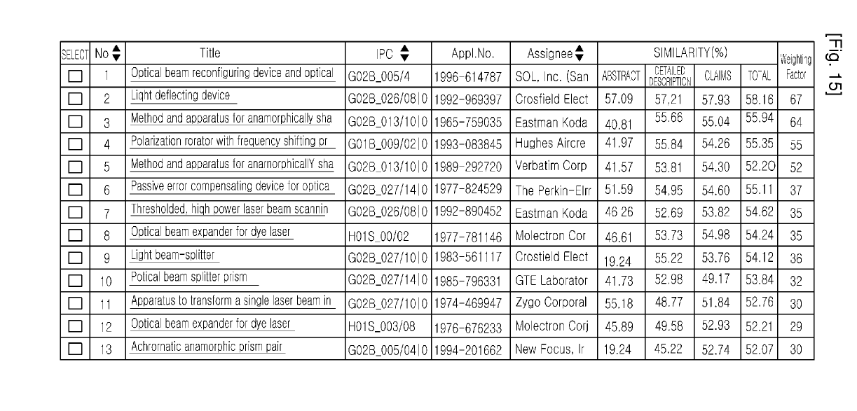

Feature vectors of the documents as illustrated in FIG. 14 can be formed by the above-mentioned selecting operation on the keyword distribution as illustrated in FIG. 13.

The representative vector calculating unit 1521 can calculate percentages of the documents with respect to the keywords selected in a descending order of the occurrence frequency. For example, in the case of the document 1, the percentages of the occurrence frequencies of the keywords A, B, E and D are 4.5%, 2.4%, 1.9%, and 1.7%, respectively.

Through those procedures, the percentages of the occurrence frequencies by keywords can be calculated with respect to the documents or representative document within the corresponding category (hereinafter, referred to as “category documents”) are calculated.

Referring to FIGS. 13 and 14, after those procedures are performed on the category documents, the percentages of the keywords with respect to the total category documents are summed, and a predetermined number of specific keywords can be selected as the representative keywords in a descending order of the summed percentages of the keywords.

For example, if the sums of the percentages of the keywords in 10 category documents among the keywords illustrated in FIG. 13 are high in order of the keywords B, A, E, D, O, C and K, the keywords B, A, E and D may be selected as the representative keywords for clustering the selected documents. The feature vectors for the respective documents are calculated using the selected representative keywords as components of the representative vector. That is, the selected representative keywords are arranged in a descending order of probability distribution, and then are selected as components of the representative vector. The operation of creating the feature vectors of the documents is performed with respect to four high-ranked keywords among the index files of the documents, that is, the keywords B, A, E and D. Although it has been described above that four keywords are selected as the representative keywords constituting the components of the representative vector and the feature vectors of the documents are created by comparing four keywords having high occurrence frequencies in the documents, it is merely exemplary and it can be modified by a system manager.

In case where the selected keywords are included in the respective documents, the vector component may be set to “1”'; otherwise, the vector component may be set to “0”.

However, instead of “1” and “0”, the vector component may be created with a value given by assigning a weighting value to the keyword.

As illustrated in FIG. 14, the feature vectors of the documents created in this manner are completed by setting “1” when the representative keyword is included and by setting “0” when the representative keyword is not included.

Through those procedures, the feature vector of the document 1 becomes (1,1,1,1), and the feature vector of the document 2 becomes (1,1,0,1). Although the components of the representative vector are created with “1” or “0”, they may also be assigned with different values according to the occurrence frequencies of the keywords.

When using a plurality of category documents, the operation of selecting the representative vector (or center vector) by using the feature vectors of those documents is performed. At this time, the vector having the greatest magnitude among the feature vectors may be selected as the representative vector for clustering.

In this case, the feature vector (1,1,1,1) of the document 1 among the feature vectors illustrated in FIG. 14 may be selected as the representative vector, and the patent documents of the second group unclassified can be clustered using the selected representative vector.

The use of the representative vector derived from the category document makes it possible to confirm whether a patent document having a predetermined similarity to a specific category is included in the second group. As mentioned above, such a similarity can also be determined by performing the feature vector or representative vector on the patent documents of the second group.

That is, the similarity between the category document belonging to a predetermined category of the first group and an unclassified document of the second group can be calculated using a dot product of the feature vectors or representative vector. For example, the value obtained by the dot product of the representative vector of the category document and the feature vector for the patent document of the second group is within a preset range, the patent documents can be clustered together with the representative vector. That is, the patent documents can be classified and clustered into the category to which the representative vector belongs.

When assuming that the representative vector is A and the feature vector of the document subject to similarity comparison is B, the document clustering unit 152 determines the similarity between the document corresponding to the vector A and the document corresponding to the vector B, depending on how far the value given by dividing the dot product of the vectors A and B by |A|² is separated from “1”.

However, in case where the dot product of the representative vector and the feature vector of the document of the second group is out of the reference value, the document is not clustered together with the representative vector, but is used as a document for other clustering.

As illustrated in FIG. 12, a twelfth document P20 belonging to the second group may be clustered into the classification A of the first group, and a twenty-first document P21 of the second group may be clustered into the classification B of the first group, depending on the calculation and determination of the similarity between the representative vector of the category and the feature vector of the document of the second group.

In addition to the above-mentioned embodiment, if the document classification is performed by the document classification module 150, the document classification module 150 can select the technology classification code (IPC or F-term) representative of the category. In this case, the classification and clustering of the documents of the second group by the document clustering unit 152 use the technology classification codes, in addition to the above-mentioned similarity determination.

For example, the document clustering unit 152 can determine the similarity to F-term of the documents of the second group by using F-terms having high frequencies with respect to categories which are results classified using the indirect citation relationship.

Since F-term classifies the documents according to the technical problems or technical solutions, the document clustering can be performed more efficiently if the similarity determination using the vectorization of the documents is used together.

Then, after the clustering is performed using the classification of the patent documents and its classification result according to the embodiment, UIs having a variety of information as illustrated in FIGS. 18 to 22 can be provided to the user by the document classification module 150 and the UI output unit 112.

FIG. 18 illustrates a first UI for information that can be acquired from the document classification and clustering.

The patent documents are classified by the document analysis system according to this embodiment, and other patent documents are clustered using the classification result. Thereafter, a patent document analysis UI like FIG. 8 can be provided to the user according to the user's period setting or applicant (or patentee) setting.

For example, when the user sets his own company as “LGE” (including a representative naming) and sets his competitor as “A company”, the number of applications by country and the evaluation values of the corresponding documents within the clustering result can be displayed in a diagram form. In particular, the evaluation values assigned by the document evaluation module 140 may be included, and the sum of the evaluation values of the documents included in the corresponding item may be displayed, or the average evaluation value of the documents included in the corresponding item may be displayed.

In addition to this information, a cites per patent (CPP), a current impact index (CII), a technological strength (TS), a technology impact index (TII), a technology cycle time (TCT), and a technology independence (TI) may be displayed.

The CPP is an index to indicate the number of citation of a patent owned by a company and is used to evaluate the technological progress of the company. The CPP can be calculated by dividing the number of citation of the corresponding patent document by a total number of patents. The CII is an index to indicate information about citation of patents of a company, for example, in the past five years and is used to evaluate information about recent impact of the company's technology. The CII can be calculated by CII=(CPP by year×a total number of patents by year/a total number of patents of the previous year).

The TS is an index to quantitatively evaluate a company's technological strength, and can be calculated by (CII×the number of patents). The TII is an index to indicate a ratio occupied by patents, which are cited by the top 10% or more in a specific technical field, with respect to a total cited number in the corresponding technical field. In order to evaluate the impact on the technical field by company, the TII can be calculated by (a cited number of patents belonging to the top 10% or more of the citation/a total cited number).

The TII is an index to evaluate a company's technological process speed and represent an average year difference corresponding to an immediate value of year difference of cited patents. The TII can be calculated by (a total sum of year differences of cited patents/the number of patents). The TI is an index to evaluate the dependence of it own company. In order to obtain the degree of citation of its own company, the TI can be calculated by (number of citation of patents owned by a company/a total number of citation).

The various kinds of the indexes can be calculated by the document classification module 150 after the document classification and clustering. The calculation result may be displayed by the UI output unit 112 in a diagram or graph as illustrated in FIGS. 18 to 22.

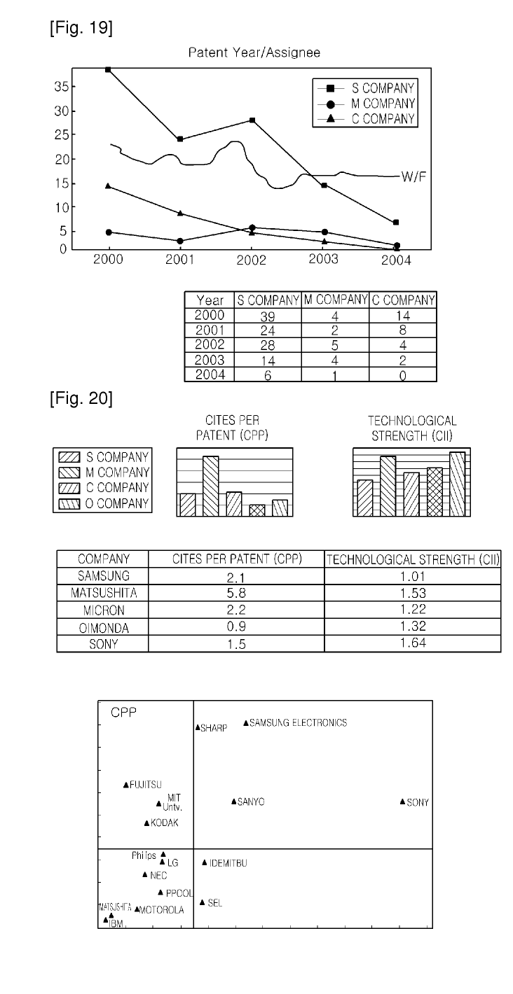

FIG. 19 illustrates a second UI for information that can be acquired from the document classification and clustering. In the case of the second UI, the number of patent documents by applicant within a set period is displayed in a diagram form, and the corresponding applicant may be selected by the user.

The average evaluation value of the patent documents in each period may be represented by W/F, and the user can confirm positions that can be the inflection points of the technological development from the W/F item displayed together with the second UI. Furthermore, if the user selects the time point where the average evaluation value W/F is high, the document classification module 150 and the UI output unit 112 according to this embodiment may provide information about the patent documents of the corresponding time point through a separate UI, or may provide the document having the highest evaluation value or the representative document at the corresponding time point through a separate UI.

FIG. 20 illustrates a third UI for information that can be acquired from the document classification and clustering. Period set by the user, CPP and CII by applicant, and UI including information about CPP and CII are illustrated in FIG. 20. A graph that displays the CPP by applicant based upon periods may further be included in the UI.

That is, it can be seen from the UI in the lower side of FIG. 20 that applicants such as Samsung Electronics and Sharp have high CPP.

In addition, information about patent activity evaluation by technical field, activity index (AI), patent portfolio analysis index (HHI), and patent diversification index (PDI) may further be provided. The patent activity evaluation by technical field is to quantitatively compare the patent activity by field within the selected period, and it can be achieved by comparing the filed documents (or published documents) by technical field.

The AI is an index to indicate a ratio occupied in a specific technical field and can be calculated by {(a total number of patents in a specific field/a total number of patents of the company)/(a total number of patents of the company/a total number of patents in all technical field)}.

The patent portfolio analysis index (HHI) is an index to confirm an aspect of competition of companies in the markets. The patent portfolio analysis index (HHI) can obtain the fields of the top ranked IPC for each company and obtain the technical field that competes with technical fields occupied by each company. For example, the number of applications per inventor indicates a relative evaluation index of the number of applications per inventor (a total number of applications/the number of company's inventors), and the number of claims per inventor indicates a relative evaluation index of claims acquired per inventor (a total number of claims/the number of company's inventors). The average remaining period of valid patents may indicate an index of the average remaining period of the owned patents (a total sum of remaining periods of valid patents/a total number of valid patents).

A joint application ratio is an index to evaluate the degree of joint research activity and can be calculated by (the number of joint applications/a total number of patents).

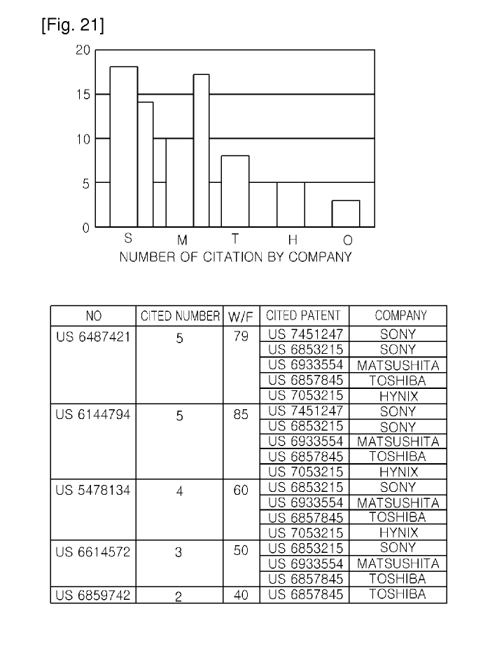

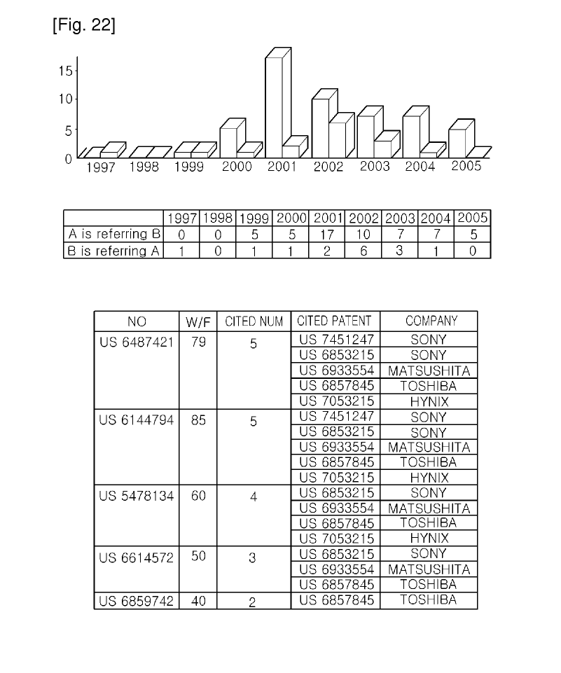

FIGS. 21 and 22 illustrate fourth and fifth UIs for information that can be acquired from the document classification and clustering.

A graph for the number of citation by company within a specific period, and a UI having a diagram for patent documents having a large number of citation are illustrated in FIGS. 21 and 22. When displaying the patent documents having a large number of citation, the evaluation values assigned by the document evaluation module 140 may also be displayed.

Furthermore, when the user selects number of a specific patent document (application number, registration number, etc.) while viewing the diagram where the number of citation is arranged in a descending order, additional information about the corresponding patent document or the corresponding specification may be provided to the user.

The document classification result or the document clustering result provided by the above-mentioned document analysis system according to this embodiment can be stored and shared with other users according to system setup. In particular, this case is very advantageous to companies or teams inducing the patent development.

### INDUSTRIAL APPLICABILITY

The present invention has the industrial applicability because it can be utilized in servers and recording media that are accessible through a network.

1. A document analysis system comprising:
a database that stores documents;
a document evaluation module that evaluates the documents by using features of the documents; and
a user interface (UI) output unit that provides an evaluation result of the documents, which is produced by the document evaluation module, upon call of the documents,
wherein the document evaluation module comprises an evaluation factor management unit that manages the features of the documents as evaluation factors; a document evaluation unit that evaluates the documents stored in the database by using the evaluation factors; and a database document management unit that makes evaluation values, which are an evaluation result of the documents from the document evaluation unit, correspond to the documents.

2. The document analysis system according to claim 1, wherein the features of the documents comprise internal features derived from contents described in the documents, and external features derived considering features of documents cited by the documents.

3. The document analysis system according to claim 2, wherein the internal features comprise maintenance period information or proceeding information derived from date information recorded in the documents, the length of claims constituting the documents, the number of independent claims, the number of dependent claims, the number of inventors recorded in the documents, or the number of applications filed by the recorded inventors.

4. The document analysis system according to claim 2, wherein the external features comprise the number of cited documents having citation relationship with the documents, or maintenance period of the cited documents.

5. The document analysis system according to claim 2, wherein the external features comprise inventor citation information.

6. The document analysis system according to claim 5, wherein the evaluation factor management unit assigns preset weighting values to items constituting the evaluation factors, and the UI output unit provides a UI that enables a user to edit the items constituting the evaluation factors or the weighting values.

7. The document analysis system according to claim 6, wherein, when the items constituting the evaluation factors or the weighting values are changed, the document evaluation unit re-evaluates the documents stored in the database by using the changed items or weighting values.

8. A document analysis system comprising:
a database that stores documents;
a document evaluation module that evaluates the documents by using features of the documents;
a prediction module that temporally analyzes the documents subject to analysis by using evaluation values that are an evaluation result of the documents by the document evaluation module; and
a UI output unit that provides a user with a temporal analysis result produced by the prediction module,
wherein the prediction module comprises a prediction information generation unit that classifies the documents subject to analysis in time order by using filing dates or publication dates of the documents, and generates trend information by using the number of documents classified based upon preset classification periods and evaluation values of the classified documents; and a prediction information management unit that sets the classification periods used as standard of the document classification or sets inflection periods obtained from the trend information, when the trend information is generated by the prediction information generation unit.

9. (canceled)

10. The document analysis system according to claim 8, wherein the UI output unit provides a UI for setting the classification periods or a UI for setting the inflection periods in order to enable the user to set the classification periods or the inflection periods.

11. The document analysis system according to claim 8, wherein the prediction information management unit arranges the trend information generated by the prediction information generation unit with the number of the documents classified according to the time order and sum of the evaluation values of the classified documents, and the UI output unit provides the user with the number of the documents classified by the prediction information management unit and the sum of the evaluation values of the corresponding documents in a graph or diagram having a time axis.

12. The document analysis system according to claim 8, wherein the prediction information generation unit uses an average value of the evaluation values per document by period as the trend information, together with the number of the documents by period and sum of the evaluation values of the classified documents.

13. The document analysis system according to claim 1, further comprising:
a document classification module that reads an indirect citation relationship between the patent documents, and clusters patent documents of a first group by using the read indirect citation relationship.

14. The document analysis system according to claim 13, wherein, when a first patent document cites a second patent document and the second patent document cites a third patent document, the document classification module classifies the first to third patent documents into the same group.

15. The document analysis system according to claim 13, wherein the document classification module comprises:
a document clustering unit that clusters the patent documents of the first group by using the read indirect citation relationship; and
a document classification unit that classifies patent documents of a second group by using information about a clustering result produced by the document clustering unit.

16. A user interface method for providing trend information of patent documents, comprising:
performing an evaluation on the patent documents, which are subject to analysis;
generating trend information through a temporal analysis on the evaluated patent documents;
displaying the trending information to an user by using horizontal axis representing a time and a vertical axis representing a number and an evaluation value of the patent documents,
wherein the displayed trend information includes at least one inflection period, the at least one inflection period is set automatically or set by the user.

17. The method according to claim 16, wherein the inflection period is a period which the number of the patent documents is rapidly changed, or the evaluation value of the patent documents are rapidly changed, or an average evaluation value per patent document is rapidly changed.

18. The method according to claim 16, further comprising displaying a year setting tag, a start and an end year tag and a number setting tag when the inflection period is set by the user.

19. The method according to claim 16, further comprising displaying information about the patent documents existing within the inflection period by using a horizontal axis representing time and a vertical axis representing a technology classification when the inflection period is set.

20. The method according to claim 19, wherein the information about the patent documents is displayed in an icon form.

21. The method according to claim 16, further comprising displaying information about a patent document having the highest evaluation value by year and technology classification when the inflection period is set.
